(19) United States
(12) Patent Application Publication
(10) Pub. No.: US 2011/0164916 A1
(43) Pub. Date: Jul. 7, 2011

(54) Autograph Ball

(76) Inventor: Robert M. Steeg, New Orleans, LA (US)

(21) Appl. No.: 12/683,856

(22) Filed: Jan. 7, 2010

(51) Int. Cl. B43K 31/00

(52) U.S. Cl. 401/195

(57) ABSTRACT

A combination writing surface and pen assembly that is used to facilitate obtaining autographs includes a sports object equivalent having a writing surface, in the shape of the object of a sport, capable of receiving writing or marking. A pen or other writing instrument is secured in a hole in the sports object equivalent.

### CROSS-REFERENCES TO RELATED APPLICATIONS

(NOT APPLICABLE)

### STATEMENT REGARDING FEDERALLY SPONSORED RESEARCH OR DEVELOPMENT

(NOT APPLICABLE)

### BACKGROUND OF THE INVENTION

The present invention relates to sports and sports memorabilia. More particularly, the present invention relates to sports ball equivalents for obtaining autographs.

It is common practice for sports fans to seek autographs of sports players on sports balls. However, it is sometimes difficult to coordinate having a sports ball and pen available together at the same time when a sports player is encountered by a fan.

The following U.S. patents are incorporated herein by reference: U.S. Pat. No. 6,736,429; U.S. Pat. No. 5,356,136; Design Pat. No. D357,500; and U.S. Pat. No. 6,082,774.

### BRIEF SUMMARY OF THE INVENTION

It would be desirable for a sports fan to facilitate obtaining player autographs, particularly using a sports object equivalent of the sport played by the player. It would also be desirable for a pen to be removably attached or built in to the object to be signed.

In an exemplary embodiment, a combination writing surface and writing instrument apparatus that is used to facilitate obtaining autographs includes a sports object equivalent having a writing surface, the sports object equivalent being in a shape of an object of a sport and having a hole therein; and a writing instrument removably securable in the hole and without a connector between an exterior end of the writing instrument and the sports object equivalent. The hole may extend completely through the sports object equivalent. Preferably, the hole is of such a diameter that the writing instrument fits snugly into the hole. The exterior end of the writing instrument or a mid-section of the writing instrument may be flared from a width smaller than a diameter of the hole to a width larger than the diameter of the hole. In one arrangement, the exterior end of the writing instrument is substantially flush with an exterior surface of the sports object equivalent when the writing instrument is inserted into the hole. The sports object equivalent may be a regulation version of a sports object, such as a ball, used in a particular sport. Graphics may be included on the sports object equivalent such as a sports team logo.

In another exemplary embodiment, an object for receiving autographs includes a sports object equivalent in a shape of an object of a sport, the sports object equivalent having a hole therein; a writing instrument sized to at least partially fit inside the hole; and a connector securing the writing instrument in the hole without connecting an exterior end of the writing instrument to the sports object equivalent. The connector may comprise a flared end of the writing instrument securable in the hole in a friction fit. Alternatively, the connector may be a spring-loaded latch mechanism, a friction member secured to the writing instrument or disposed inside the hole, or a snap assembly including cooperable parts respectively secured to the writing instrument and in the hole.

In yet another exemplary embodiment, an object for receiving autographs includes a sports object equivalent in a shape of an object of a sport, the sports object equivalent having a hole therein; a writing instrument sized to at least partially fit inside the hole; and structure for releasably securing the writing instrument to the sports object equivalent without a cord.

### BRIEF DESCRIPTION OF THE DRAWINGS

For a further understanding of the nature, objects, and advantages of the present invention, reference should be had to the following detailed description, read in conjunction with the following drawing, wherein:

FIG. 1 shows a cross-section of the apparatus of the present invention; and

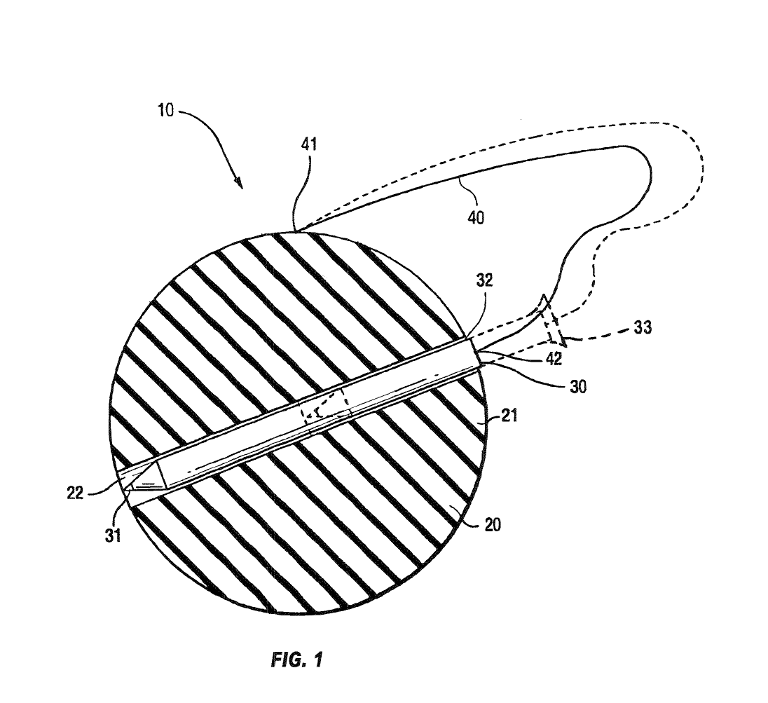

FIG. 2 shows a cross-section of an alternative embodiment.

### DETAILED DESCRIPTION OF THE INVENTION

The Autograph-Ball according to the present invention is a combination writing surface and writing instrument assembly that is used to facilitate the obtaining of autographs. The writing surface 21 is on a ball equivalent 20 in the shape of the object of a sport—usually a ball of some kind, but it could also take other shapes such as a hockey puck, golf club head, or the like. For ease of reference herein, the ball equivalent 20 with writing surface 21 will be referred to simply as a “ball,” although other shapes may be used.

The ball 20 is capable of receiving writing or marking The ball 20 may be a “regulation” version of a ball that is actually used in a particular sport, such as a hardball (baseball) or softball. Or it may be a different-scale version or other replica, having one or more qualities (such as size, weight and/or color) that are different from the “regulation” version used in a particular sport, such as a golf ball, football, tennis ball, or hockey puck.

The writing instrument 30 is any pencil, pen, marker or other instrument capable of making an image such as an autograph or other written mark. For ease of reference herein, the writing instrument will be referred to simply as a “pen,” although any writing instrument may be utilized.

There is attached to the non-writing end 32 of the pen 30 a chain or cord 40 or other flexible and preferably durable means of connecting the pen to the ball (for ease of reference, it will be called the “cord”). The cord 40 may be coiled or straight and may be made of plastic, metal, string or any other flexible material. The first end 41 of the cord is attached to the ball 20, and the second end 42 is attached to the pen 30. The means of attachment of the cord on both ends (to the ball and to the pen) will be such that achieves a strong, durable attachment, not easily torn away or broken (such as with nail, tack, or durable glue) and is preferably permanent. Alternatively, the cord could be easily removed via structure that enables detachment and reattachment, such as a clip, a hook and loop fastener, or the like.

A hole 22 drilled into the ball 20 may extend through the ball or may extend only part way into the ball (shown in phantom). The hole 22 is preferably of such a diameter that the pen fits snugly into it. The pen 30 may extend through the hole 22, so that the writing end 31 of the pen 30 sticks out the other end of the ball when the pen is inserted. Alternatively, the pen may not extend through the ball, so that the writing end 31 of the pen 30 remains inside the ball 20 when the pen 30 is inserted. The non-writing end 32 of the pen 30 may be flush with the surface 21 of the ball, or the non-writing end may protrude outside the opening into which the pen was inserted. The non-writing end 32 of the pen 30 may be flared outward 33 to prevent the pen 30 from being able to be inserted all the way inside the ball 20. The pen may still alternatively be bowed in the middle so that its wider mid-section catches on the inside of the hole to secure the pen in the hole.

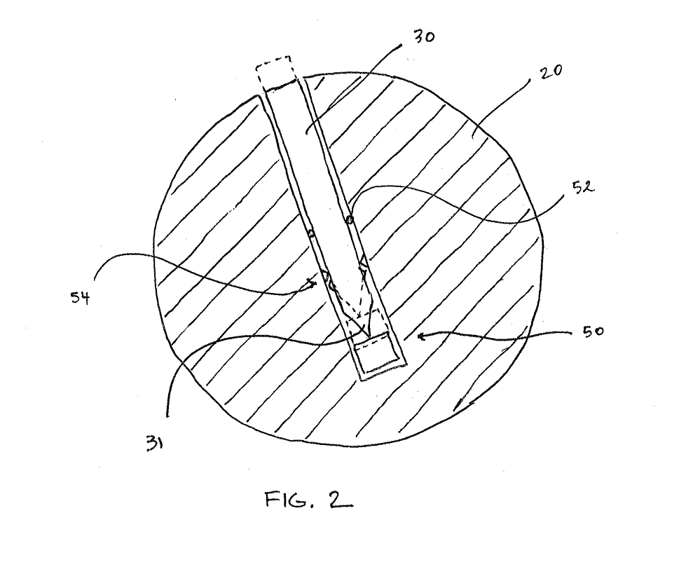

Alternative embodiments are shown is FIG. 2. It may be desirable to provide the writing instrument 30 in engagement with the ball 20 but without including a connector between the exterior end of the pen 30 and the ball 20. For example, a spring-loaded latch mechanism 50 may be provided at a suitable location in the ball 20, for example at the bottom of the hole 22 or alternatively in the middle or even at the outer edge where the hole meets the surface of the ball. The latch mechanism itself is known, and those of ordinary skill in the art will appreciate various alternatives for suitable structure. In an exemplary application, with the pen 30 inserted in the hole, the latch mechanism 50 is disposed in a retracted position (shown in solid line). Using known mechanical structure, in order to release the pen 30 from the hole, the user presses down on the pen to release the latch mechanism 50 from its retracted position to an extended position (shown in phantom). In the extended position, the latch mechanism 50 urges an end of the pen 30 outside of the hole to be easily grasped by the user.

An alternative (or additional) connector is a friction member 52, shown as an O-ring, that is either secured to the pen 30 or disposed inside the hole. The friction member 52 should be formed of a suitably pliable material, such as rubber, plastic or the like to receive the pen in a friction fit without making it too difficult to remove the pen once inserted.

Yet another alternative connector is shown in FIG. 2 as a snap assembly 54 including cooperable parts respectively secured to the pen 30 and in the hole. The protrusions shown in FIG. 2 are exemplary, but the user may secure the pen 30 by pushing the snap part secured to the pen 30 over the snap part secured in the hole. Conversely, the user simply pulls the pen 30 from the hole by exerting a force greater than the resistance provided by the cooperable parts of the snap assembly 54.

The Autograph-Ball is an invention that facilitates obtaining autographs on an object (such as a ball) by having a writing surface and a writing instrument attached to each other in an assembly that both (a) is easy to handle as one, unified whole and (b) keeps the writing instrument permanently attached in the vicinity of the writing surface.

The advantages of this invention include:

(1) The pen attached to the ball will not be dislodged or lost or discarded or misplaced, which would render the device meaningless as a means of obtaining autographs.

(2) In some embodiments, even though attached, the pen can be pulled away from the ball to a distance that is comfortable for writing.

(3) In the attached embodiments, the pen remains attached to the ball even as it is being used to sign or mark the ball; in the detachable embodiments, the signed ball can be displayed without the pen attached.

(4) When not in use, the writing instrument is inserted into the ball, so that the ball-and-pen combination may be handled as one unified assembly.

(5) By being inserted into the ball, the pen becomes integrated into the physical structure of the ball, and the entire assembly feels and seems like a ball. This establishes an identity between the game being played by the athlete whose autograph is desired and the assembly being used to obtain the autograph. It makes the autograph seeker more likely to take the autograph-ball with him or her to a sporting event. The assembly preferably has the “heft” and “feel” of a real ball, and the attachment of the pen to the ball does not prevent this from being so.

(6) The assembly (with pen inserted) is easily transportable to and from the place where the signing of the autographs takes place. The pen remains attached and out of the way during transport.

(7) The assembly (with pen inserted) may be easily tossed to and from the person from whom the autograph is sought, and the pen remains attached and out of the way during this action.

While the invention has been described in connection with what is presently considered to be the most practical and preferred embodiments, it is to be understood that the invention is not to be limited to the disclosed embodiments, but on the contrary, is intended to cover various modifications and equivalent arrangements included within the spirit and scope of the appended claims.

1. A combination writing surface and writing instrument apparatus that is used to facilitate obtaining autographs, comprising:
a sports object equivalent having a writing surface, the sports object equivalent being in a shape of an object of a sport and having a hole therein; and
a writing instrument removably securable in the hole and without a connector between an exterior end of the writing instrument and the sports object equivalent.

2. The apparatus according to claim 1, wherein the hole extends completely through the sports object equivalent.

3. The apparatus according to claim 1, wherein the hole is of such a diameter that the writing instrument fits snugly into the hole.

4. The apparatus according to claim 1, wherein one of the exterior end of the writing instrument or a mid-section of the writing instrument is flared from a width smaller than a diameter of the hole to a width larger than the diameter of the hole.

5. The apparatus according to claim 1, wherein the exterior end of the writing instrument is substantially flush with an exterior surface of the sports object equivalent when the writing instrument is inserted into the hole.

6. The apparatus according to claim 1, wherein the sports object equivalent is a regulation version of a sports object used in a particular sport.

7. The apparatus according to claim 6, wherein the sports object equivalent is a ball.

8. The apparatus according to claim 1, further comprising graphics on the sports object equivalent.

9. The apparatus according to claim 1, wherein the sports object equivalent bears a logo of a sports team or of a product.

10. An object for receiving autographs, the object comprising:
a sports object equivalent in a shape of an object of a sport, the sports object equivalent having a hole therein;
a writing instrument sized to at least partially fit inside the hole; and
a connector securing the writing instrument in the hole without connecting an exterior end of the writing instrument to the sports object equivalent.

11. An object according to claim 10, wherein the connector comprises a flared end of the writing instrument securable in the hole in a friction fit.

12. An object according to claim 10, wherein the connector comprises a spring-loaded latch mechanism.

13. An object according to claim 10, wherein the connector comprises a friction member secured to the writing instrument or disposed inside the hole.

14. An object according to claim 10, wherein the connector comprises a snap assembly including cooperable parts respectively secured to the writing instrument and in the hole.

15. An object for receiving autographs, the object comprising:
a sports object equivalent in a shape of an object of a sport, the sports object equivalent having a hole therein;
a writing instrument sized to at least partially fit inside the hole; and
means for releasably securing the writing instrument to the sports object equivalent without a cord.
